(19) United States
(12) Patent Application Publication
(10) Pub. No.: US 2003/0041502 A1
(43) Pub. Date: Mar. 6, 2003

(54) Fishing line for fly fishing

(76) Inventors: Michael Mauri, Polling (DE); Thomas Michael, Muhlheim (DE)

Correspondence Address: MANELLI DENISON & SELTER, 2000 M STREET NW SUITE 700, WASHINGTON, DC, 20036-3307, US

(21) Appl. No.: 09/942,975

(22) Filed: Aug. 31, 2001

(51) Int. Cl. A01K 91/00

(52) U.S. Cl. 43/44.98

(57) ABSTRACT

A fishing line for fly fishing includes a front-taper (2), a first belly (3) and a running line (5). At least one additional belly (4) is located between the first belly (3) and the running line (5).

### DESCRIPTION

The invention concerns a Fishing Line for Fly Fishing with a first thickened section (Belly) and a running-line.

Such fishing lines are customary and commonly known under the term belly-lines (,,Keulenschnürc”) or WF-lines (weight-forward). The Leaders are attached to such fishing lines either in a one-piece construction, f.c. as referred to in U.S. Pat. No. 6,170,192 B 1, or, knotted to the fishing line as shown for example in WO 96/22682. Such Leaders may either be continuously or stepwise tapered towards the front end—where the fly is attached—so that they are thin enough at the front end to easily fit through the eye of the flyhook

There are other types of flylines which have a constant diameter and are tapered to a smaller diameter only to one end (taper), as for example referred to in JP-Abs. 10337139 A, or, flylines tapered to a smaller diameter at both ends, so called DT-lines (double-taper).

The casting performance of a WF-line depends mostly on a thickened front section of the line, the so called belly. This section incorporates the weight which is necessary for casting whereas the so called running-line section, which leads from the belly's rear end to the fishing reel, has no weight for casting.

The belly also determines how fast the fishing rod can be loaded, i.e. the energy is transmitted from the body into the line and the cast may be effected.

The invention deals with the problem to provide for a fish line for flyfishing which loads the rod as fast as possible, and which reduces the number of false-casts while providing for a stable flight of the belly-section at the same time.

The object of the invention is solved—in connection with the characteristics of the preamble of claim 1—by attaching at least one additional thickened section (second belly) between the first thickened section (first belly) and the running line. This especially allows an easier transportation of large flies, a loading of the rod with loss line when doing trick-shooting, a minimizing of the need for false-casts and a stabilization of the flight of the first belly during long distance casts.

It is especially advantegous if two bellies are used as the second belly stabilizes the first belly while the line is in the air.

A development with further distinct advantages provides for a first belly with a total length between approximately 6 m and 15 m whereas the second belly has a total length of between approximately 7 m and 15 m.

Further advantageous versions of tie invention are described within the further claims.

Further details of the invention are described within the schematic drawings.

The drawings show:

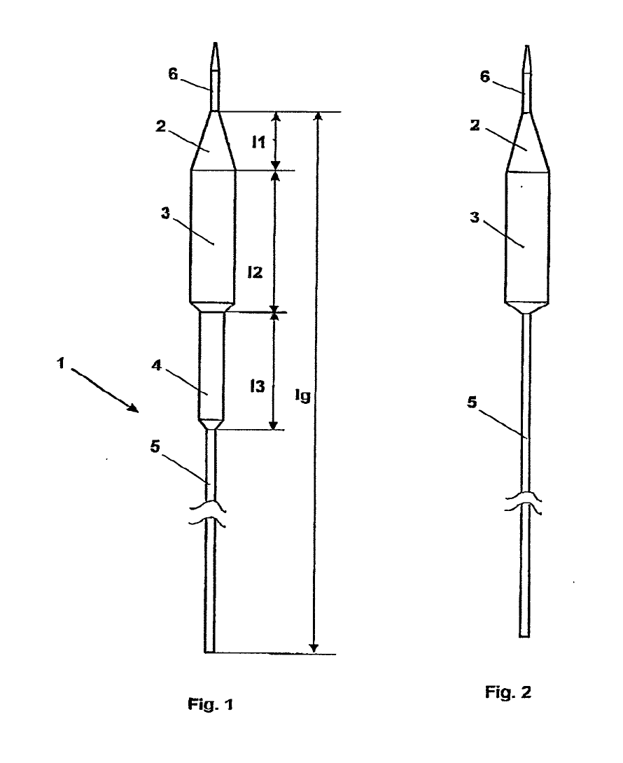

FIG. 1 Fishing line for Fly Fishing according to the invention.

FIG. 2 Fishing line for Fly Fishing known to the art.

FIG. 1 shows a Fishing Line for Fly Fishing (1) according to the invention. The line consists of different sections. The front-taper (2) serves to taper the front section in order to allow an easier attachment of a so called leader (6) and to provide for a consistent transfer of energy from one belly to the leader.

The leader (6) itself can either be conical and continuously taped towards the front end, or, be tapered in two or more steps.

The length (L1) of the front-taper (2) may range between approximately 0.3 m and 2 m. The leader (6) may have a length between approximately 1 m and 7 m The front-taper (2) is followed by a so called belly. This belly consists of a first belly (3) with an approximate length (L2) between 6 m and 35 m and a second belly (4) with a length of approximately 7 m and 15 m.

The second belly (4) is followed by a so called running-line (5). The total length (Lg) of the Fishing Line for Fly Fishing (1) is approximately 27 m-38 m.

The line-diameter may range between approximately 0.4 mm and 1.2 mm at the front end of the front-taper (2), between approximately 0.8 mm and 3 mm at the first belly (3). between approximately 0.4 mm and 2 mm at the second belly (4) and between approximately 0.4 mm and 1 mm at the running-line (5).

To compare, FIG. 2 shows a Fishing Line for Fly Fishing known to the art. It is easily perceivable that the line contains only one belly (3).

### Reference Nos.

1 Fishing Line for Fly Fishing

2 front-taper

3 first belly

4 second belly

5 running-line

6 leader

L1 length of front-taper

L2 length of first belly

L3 length of second belly

1 g total length of Fishing Line

1. Fishing Line for Fly Fishing with a front-taper (2), a first belly (3) and a running-line (5), characterized in such manner that at least one additional belly (second belly (4)) is located between the first belly (3) and the running line(5).

2. Fishing Line for Fly Fishing of claim 1, characterized in such manner that it contains two belly sections (first belly (3) and second belly (4)).

3. Fishing Line for Fly Fishing of claim 1 or 2, characterized in such manner that the length of the first belly (3) measures between approximately 6 m and 15 m.

4. Fishing Line for Fly Fishing of claim 1, through 3, characterized in such manner that the length of the second belly (4) measures between approximately 7 m and 15 m.

5. Fishing Line for Fly Fishing of claim 1, through 4, characterized in such manner that the diameter of the first belly (3) measures between approximately 0.8 mm and 3 mm.

6. Fishing Line for Fly Fishing of claim 1, through 5, characterized in such manner that the diameter of the second belly (4) measures between approximately 0.4 mm and 2 mm.
